(19) United States
(12) Patent Application Publication
(10) Pub. No.: US 2022/0302519 A1
(43) Pub. Date: Sep. 22, 2022

(54) BATTERY COOLING SYSTEM

(71) Applicants: TOYOTA JIDOSHA KABUSHIKI KAISHA, Toyota-shi Aichi-ken (JP); SUBARU CORPORATION, Tokyo (JP)

(72) Inventors: Haruka Tsuruta, Toyota-shi Aichi-ken (JP); Satoshi Furukawa, Kariya-shi Aichi-ken (JP); Mitsuyo Omura, Kariya-shi Aichi-ken (JP)

(21) Appl. No.: 17/586,218

(22) Filed: Jan. 27, 2022

(30) Foreign Application Priority Data
Mar. 22, 2021 (JP) 2021-047580

(51) Int. Cl. H01M 10/635; H01M 10/48; H01M 10/613; H01M 10/6568; H01M 10/625

(52) U.S. Cl. CPC H01M 10/635; H01M 10/486; H01M 10/613; H01M 10/6568; H01M 10/625; H01M 2220/20

(57) ABSTRACT

A battery cooling system includes: a battery cooling circuit in which a heating medium that cools a battery circulates and include a cooler path and a battery path; a cooler that cools the heating medium; the battery; a combined cooling circuit; a switching valve configured to selectively allow and cut off communication between at least two paths selected from the cooler path, the battery path, and the combined cooling circuit; a heating medium temperature sensor that detects a temperature of the heating medium; an environment temperature sensor that detects a temperature of the environment; a battery temperature sensor that acquires a temperature of the battery; and a control device. The control device determines whether there is an abnormality in the switching valve based on the heating medium temperature and a threshold temperature that is associated with a maximum temperature out of the environment temperature and the battery temperature.

### CROSS-REFERENCE TO RELATED APPLICATION

This application claims priority to Japanese Patent Application No. 2021-047580 filed on Mar. 22, 2021, incorporated herein by reference in its entirety.

### BACKGROUND

### 1. Technical Field

The technique disclosed herein relate to systems for cooling a battery.

### 2. Description of Related Art

Japanese Unexamined Patent Application Publication No. 2020-4484 (JP 2020-4484 A) discloses a battery cooling system for a vehicle. This kind of battery cooling system includes a battery cooling circuit that circulates a heating medium for cooling a battery.

### SUMMARY

A path in such a battery cooling system may be connected to another cooling circuit such as a circuit for cooling an electric device that generates heat using electric power supplied from the battery. In this case, a switching valve is provided at a connection portion between the battery cooling system and the other cooling circuit. This switching valve is a valve configured to selectively allow a path in the battery cooling system and a path in the other cooling circuit to communicate with each other and cut off the communication between each other.

When the switching valve is damaged or deteriorated, the function of the switching valve deteriorates, and the heating medium may unintentionally flow in from the other cooling circuit via the switching valve, or the heating medium may unintentionally flow out of the battery cooling circuit via the switching valve. Deterioration of the function of the switching valve will affect the battery cooling performance.

However, it is difficult to determine whether there is an abnormality such as damage or deterioration in the switching valve because a certain amount of work is required to individually check the switching valve or evaluate the operation of the switching valve. Moreover, it is required that an abnormality of the switching valve be detected promptly. The present specification provides a technique capable of solving such problems.

The technique disclosed in the present specification is embodied in a battery cooling system. A battery cooling system according to one aspect of the present disclosure includes: a battery cooling circuit in which a heating medium that cools a battery circulates, the battery cooling circuit including a cooler path and a battery path, the cooler path being a path for cooling the heating medium, and the cooler path and the battery path being connected to each other; a cooler that cools the heating medium in the cooler path; the battery that is cooled by the battery path; a combined cooling circuit that is a cooling circuit connected to the cooler path and the battery path at a connection portion between the cooler path and the battery path, the combined cooling circuit being a cooling circuit in which the same heating medium circulates; a switching valve located at the connection portion between the cooler path and the battery path and configured to selectively allow and cut off communication between at least two paths, the at least two paths being selected from the cooler path, the battery path, and the combined cooling circuit; a heating medium temperature sensor that detects a heating medium temperature, the heating medium temperature being a temperature of the heating medium circulating in the battery cooling circuit; an environment temperature sensor that detects an environment temperature, the environment temperature being a temperature of an environment in which the battery cooling system is located; a battery temperature sensor that acquires a battery temperature, the battery temperature being a temperature of the battery; and a control device. The control device determines whether there is an abnormality in the switching valve based on the heating medium temperature and a threshold temperature, the threshold temperature being a temperature associated with a maximum temperature out of the environment temperature and the battery temperature.

The inventors found that, when the battery cooling system is operating normally, the temperature of the heating medium circulating in the battery cooling circuit of the battery cooling system maintains a certain relationship with the temperature of the environment in which the battery cooling system is located and/or the battery temperature. The inventors also found that whether there is an abnormality in the switching valve can be determined by setting the threshold temperature associated with the maximum temperature out of the environment temperature and the battery temperature.

According to this battery cooling system, the battery cooling system itself can determine whether there is an abnormality in the valve body. That is, whether there is an abnormality in the switching valve can be determined without checking the switching valve itself, evaluating the operation of the switching valve, etc. It is therefore possible to avoid stopping the battery cooling system in order to determine whether there is an abnormality in the switching valve, and it is possible to easily and promptly determine whether there is an abnormality in the switching valve based on the heating medium temperature and the threshold temperature.

The threshold temperature associated with the maximum temperature out of the environment temperature and the battery temperature is not particularly limited. Although it depends on the environment temperature and the battery temperature, the threshold temperature can be any value by which an abnormality of the switching valve can be detected, and can be obtained by, for example, experiments or simulations.

In the battery cooling system, the threshold temperature may be a temperature that is higher than the maximum temperature by a predetermined temperature.

In the battery cooling system, the threshold temperature may be set to a temperature that is higher than the maximum temperature by a temperature in a range of 5° C. to 15° C.

In the battery cooling system, the heating medium temperature sensor may be located downstream of the switching valve.

In the battery cooling system, the switching valve may be located at a connection portion between a downstream end of the cooler path and an upstream end of the battery path.

In the battery cooling system, the switching valve may be a switching valve configured to selectively allow and cut off communication between at least two of the cooler path, the battery path, and a path in the combined cooling circuit.

In the battery cooling system, the combined cooling circuit may include a heat-related device path and a radiator path, the heat-related device path including a heat-related device that operates using power of the battery, and the radiator path including a radiator that exchanges heat between the heating medium cooling the heat-related device and outside air, and the combined cooling circuit may be a cooling circuit in which the heating medium circulates.

In the battery cooling system, the combined cooling circuit may further include a bypass path that bypasses the radiator path.

The battery cooling system may further include a storage unit for the heating medium, the storage unit being located at another connection portion between the cooler path and the battery path, and the battery cooling circuit and the combined cooling circuit may be connected via the switching valve and the storage unit.

In the battery cooling system, when the heating medium starts circulating in the battery cooling circuit, the control device may determine whether there is the abnormality in the switching valve based on the heating medium temperature and the threshold temperature after elapse of a certain amount of time from start of circulation of the heating medium.

The battery cooling system may further include a first other thermal circuit, the first other thermal circuit including a heat exchanger that cools the heating medium by heat exchange with another heating medium.

The battery cooling system may further include a second other thermal circuit that heats the other heating medium by heat exchange with a further another heating medium.

In the battery cooling system, the battery may be a battery for a vehicle.

In the battery cooling system, the control device may compare the heating medium temperature and the threshold temperature, and determine that there is the abnormality in the switching valve when the heating medium temperature is equal to or higher than the threshold temperature.

In the battery cooling system, the switching valve may be a switching valve configured to selectively allow the cooler path and the battery path to communicate with the combined cooling circuit and cut off the communication of the cooler path and the battery path with the combined cooling circuit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a circuit diagram showing an example of a thermal management system including a battery cooling system;

FIG. 2 is a circuit diagram showing an example of a battery cooling operation mode in the thermal management system including the battery cooling system;

FIG. 3 shows an example of a switching valve abnormality determination process in the battery cooling system;

FIG. 4 is a circuit diagram showing another example of the battery cooling operation mode in the thermal management system including the battery cooling system;

FIG. 5 is a circuit diagram showing still another example of the battery cooling operation mode in the thermal management system including the battery cooling system; and

FIG. 6 is a circuit diagram showing another example of the thermal management system including the battery cooling system.

### DETAILED DESCRIPTION OF EMBODIMENTS

In an embodiment of the present disclosure, a threshold temperature may be the temperature that is higher than the maximum temperature by a predetermined temperature. With this configuration, whether there is an abnormality in a switching valve can be easily determined.

In an embodiment of the present disclosure, the threshold temperature may be set to the temperature that is higher than the maximum temperature by a temperature in a range of 5° C. to 15° C. With this configuration, whether there is an abnormality in the switching valve can be accurately determined.

In an embodiment of the present disclosure, a heating medium temperature sensor may be located downstream of the switching valve. With this configuration, whether there is an abnormality in the switching valve can be accurately determined.

In an embodiment of the present disclosure, the switching valve may be located at a connection portion between a downstream end of a cooler path and an upstream end of a battery path.

In an embodiment of the present disclosure, the switching valve may be the switching valve configured to selectively allow and cut off communication between at least two of the cooler path, the battery path, and a path in a combined cooling circuit. With this configuration, the battery cooling circuit and the combined cooling circuit with high thermal efficiency can be designed.

In an embodiment of the present disclosure, the combined cooling circuit may include a heat-related device path and a radiator path, the heat-related device path including a heat-related device that operates using power of the battery, and the radiator path including a radiator that exchanges heat between the heating medium cooling the heat-related device and outside air. With this configuration, the circuits for cooling the battery and the heat-related device that are associated with each other can be switched as appropriate by the switching valve to circulate the heating medium.

In an embodiment of the present disclosure, the combined cooling circuit may further include a bypass path that bypasses the radiator path. With this configuration, temperature control for the heat-related device in the combined cooling circuit may be efficiently performed.

In an embodiment of the present disclosure, the battery cooling system may further include a storage unit for the heating medium, the storage unit being located at the other connection portion between the cooler path and the battery path, and the battery cooling circuit and the combined cooling circuit can be connected via the switching valve and the storage unit. With this configuration, temperature control for the heat-related device in the combined cooling circuit may be efficiently performed.

In an embodiment of the present disclosure, when the heating medium starts circulating in the battery cooling circuit, the control device may determine whether there is an abnormality in the switching valve based on the heating medium temperature and the threshold temperature after elapse of a certain amount of time from the start of the circulation of the heating medium. At the start of the circulation of the heating medium in the battery cooling circuit, the temperature of the heating medium circulating in the battery cooling circuit is not uniform. It is therefore difficult to detect the heating medium temperature to be used to make the determination. As a result, the control device may erroneously determine that the switching valve is normal or abnormal. By using the heating medium temperature detected after the elapse of the certain amount of time from the start of the circulation of the heating medium and the threshold temperature, whether there is an abnormality in the switching valve can be accurately determined.

In an embodiment of the present disclosure, the battery cooling system may further include a first other thermal circuit, the first other thermal circuit including a heat exchanger that cools the heating medium by heat exchange with another heating medium. The battery cooling system may further include a second other thermal circuit that heats the other heating medium by heat exchange with a further another heating medium. With this configuration, heat absorbed by the heating medium can be efficiently used.

In an embodiment of the present disclosure, the battery may be a battery for a vehicle. With this configuration, heat generated in the vehicle can be efficiently used.

Hereinafter, the battery cooling system will be described with reference to the drawings. A thermal management system 100 that will be described below is mounted on an electrically powered vehicle and, for example, heats and cools components in the electrically powered vehicle and air-conditions the vehicle by circulating a heating medium such as antifreeze or cooling medium. Of the thermal management system 100, a battery cooling system disclosed in the present specification includes, as its components, at least a low temperature radiator circuit 10, a first temperature sensor 44, a second temperature sensor 95, a third temperature sensor 97, and a control device 98. The thermal management system 100 can be called a battery cooling system as long as it includes these elements.

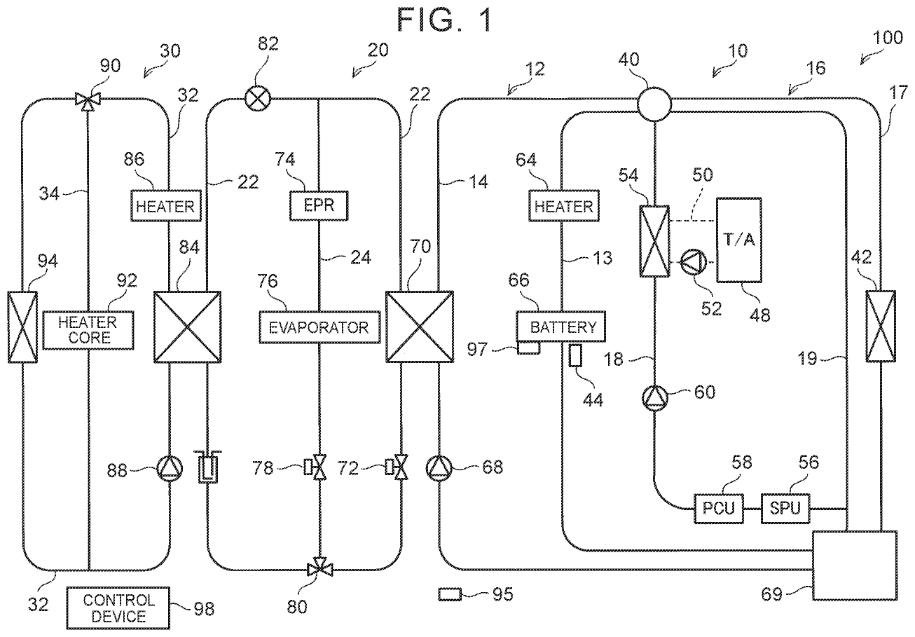

As shown in FIG. 1, the thermal management system 100 includes: the low temperature radiator circuit 10 including a low temperature radiator 42; a high temperature radiator circuit 30 including a high temperature radiator 94; a heat pump circuit 20 thermally interposed between the two radiator circuits 10, 30; and the control device 98. These circuits 10, 20, and 30 are thermally connected, but their paths through which the heating medium flows are independent of each other. In the two radiator circuits 10, 30, antifreeze such as long life coolant is used as the heating medium, although the heating medium is not particularly limited. In the heat pump circuit 20, a cooling medium (heating medium for a refrigeration cycle) such as hydrofluorocarbon is used as the heating medium.

The low temperature radiator circuit 10 and the heat pump circuit 20 are thermally connected via a chiller 70, and the heat pump circuit 20 and the high temperature radiator circuit 30 are thermally connected via a condenser 84. The chiller 70 and the condenser 84 are kinds of heat exchanger. The chiller 70 functions as an evaporator in the low temperature radiator circuit 10 and can transfer heat from the heating medium in the low temperature radiator circuit 10 to the heating medium in the heat pump circuit 20. The condenser 84 functions as an evaporator in the heat pump circuit 20 and can transfer heat from the heating medium in the heat pump circuit 20 to the heating medium in the high temperature radiator circuit 30.

The low temperature radiator circuit 10 includes a first circuit 12 that cools a secondary battery (rechargeable battery) for a vehicle (hereinafter simply referred to as the battery) 66, and a second circuit 16 that cools heat-related devices.

### First Circuit

The first circuit 12 is a circulation path that circulates the heating medium between the chiller 70 and the battery 66. The first circuit 12 mainly includes a battery path 13 and a chiller path 14. A downstream end of the battery path 13 is connected to an upstream end of the chiller path 14, and a downstream end of the chiller path 14 is connected to an upstream end of the battery path 13. The first circuit 12 is an example of the battery cooling circuit disclosed in the present specification, and the battery path 13 is an example of the battery path disclosed in the present specification. The chiller 70 is an example of the cooler disclosed in the present specification, and the chiller path 14 is an example of the cooler path disclosed in the present specification.

The battery path 13 includes a heater 64, the battery 66, and the first temperature sensor 44 in this order from the upstream side. The first temperature sensor 44 is located on the outlet side of the battery 66 and detects the heating medium temperature. The battery 66 supplies electric power to a built-in motor of a transaxle 48 via a smart power unit (SPU) 56 and a power control unit (PCU) 58 that will be described later. The battery 66 is cooled by heat exchange with the heating medium flowing through the battery path 13. The heater 64 is an electric heater. The heater 64 can heat the battery 66 by heating the heating medium in the battery path 13 as needed. The first temperature sensor 44 is connected to the control device 98, and the temperature detected by the first temperature sensor 44 (that is, the temperature of the heating medium flowing through the first circuit 12) is sent to the control device 98.

The chiller path 14 includes a first pump 68 that circulates the heating medium and the chiller 70 in this order from the upstream side. The position of the first pump 68 is not limited to the upstream of the chiller 70, and is set as appropriate in the low temperature radiator circuit 10.

The upstream end of the battery path 13 and the downstream end of the chiller path 14 are connected via a first switching valve 40. The downstream end of the battery path 13 and the upstream end of the chiller path 14 are connected via a reservoir tank 69. The reservoir tank 69 includes a heating medium storage unit for removing air bubbles from the heating medium. The reservoir tank 69 is an example of the storage unit disclosed in the present specification.

The first switching valve 40 is a five-way valve, and connects three paths 17, 18, and 19 of the second circuit 16 in addition to the two paths 13, 14 of the first circuit 12. Regarding the first circuit 12, the first switching valve 40 can circulate the heating medium in the first circuit 12, switch the heating medium from the chiller path 14 to the low temperature radiator path 17 of the second circuit 16, and adjust the ratio of the flow rates in the paths. That is, the heating medium is shared and flows in the first circuit 12 and the second circuit 16. The first switching valve 40 is connected to the control device 98, and the control device 98 controls the operation of the first switching valve 40. The first switching valve 40 is an example of the switching valve disclosed in the present specification.

### Second Circuit

The second circuit 16 is a circulation path that circulates the heating medium between the low temperature radiator 42 and some heat-related devices. The second circuit 16 mainly includes the low temperature radiator path 17 and the heat-related device path 18. An upstream end of the low temperature radiator path 17 and a downstream end of the heat-related device path 18 are connected via the first switching valve 40 that is shared with the first circuit 12. A downstream end of the low temperature radiator path 17 and an upstream end of the heat-related device path 18 are connected via the reservoir tank 69 that is shared with the first circuit 12. The second circuit 16 is an example of the combined cooling circuit disclosed in the present specification. The low temperature radiator 42 is shared between the first circuit 12 and the second circuit 16. The low temperature radiator circuit 10 can thus be efficiently configured.

The low temperature radiator path 17 includes the low temperature radiator 42. The heat-related device path 18 includes a second pump 60 that circulates the heating medium. The heat-related devices in the heat-related device path 18 include, for example, an oil cooler 54, a transaxle 48, and the power conversion devices. For example, the power conversion devices in the present embodiment include the SPU 56 including a direct current to direct current (DC-to-DC) converter and the PCU 58 including an inverter.

The oil cooler 54 is a kind of heat exchanger and is thermally connected to the transaxle 48 via an oil circulation path 50. The transaxle 48 includes a traction motor that drives a wheel, a speed reducer interposed between the traction motor and the wheel, etc. The oil circulation path 50 includes an oil pump 52 and circulates oil, which is the heating medium, between the oil cooler 54 and the transaxle 48. The heat of the transaxle 48 is thus transferred to the oil cooler 54 and is further transferred from the oil cooler 54 to the heating medium in the second circuit 16. The transaxle 48, the oil cooler 54, the power conversion devices etc. in the present embodiment are examples of the heat-related devices in the second circuit 16.

The second circuit 16 further includes the bypass path 19. The bypass path 19 bypasses the low temperature radiator 42. The bypass path 19 branches at the first switching valve 40 located at the connection portion between the low temperature radiator path 17 and the heat-related device path 18, bypasses the low temperature radiator 42, and connects to the reservoir tank 69 located at the downstream end of the low temperature radiator path 17.

In addition to controlling the flow paths and the flow rates as described above, the first switching valve 40 can also control the flow paths and the flow rates in the flow paths for the second circuit 16. Specifically, the first switching valve 40 can control the flow paths for heating medium circulation by causing the heating medium from the heat-related device path 18 to flow into the low temperature radiator path 17 to circulate the heating medium in the second circuit 16 and by causing the heating medium from the heat-related device path 18 to flow into the bypass path 19 so that the heating medium bypasses the low temperature radiator 42.

The heat pump circuit 20 mainly includes a main circuit 22 and a cooling path 24. The main circuit 22 is a circulation path that circulates the heating medium (cooling medium) between the chiller 70 and the condenser 84. The main circuit 22 further includes an expansion valve 72 and a compressor 82 and forms a so-called refrigeration cycle. The expansion valve 72 is located on the upstream of the chiller 70, and the compressor 82 is located on the upstream of the condenser 84. That is, the heating medium circulates counterclockwise in FIG. 1 in the main circuit 22. The main circuit 22 transfers heat from the low temperature radiator circuit 10 connected to the chiller 70 to the high temperature radiator circuit 30 connected to the condenser 84. The expansion valve 72 and the compressor 82 are connected to the control device 98, and the control device 98 controls the operation of the expansion valve 72 and the compressor 82. The heat pump circuit 20 is an example of the first other thermal circuit disclosed in the present specification.

The cooling path 24 is in parallel with the chiller 70 and bypasses the chiller 70. An expansion valve 78, an evaporator 76 for cooling, and an evaporator pressure regulator (EPR) 74 are located in the cooling path 24. The cooling path 24 branches from the main circuit 22 on the upstream of the chiller 70 and joins the main circuit 22 on the downstream of the chiller 70. A second switching valve 80 is located at an upstream end of the cooling path 24 (that is, the branch point from the main circuit 22). The second switching valve 80 can switch the flow of the heating medium in the heat pump circuit 20 between the chiller 70 and the evaporator 76 and adjust the ratio of the flow rates in the flow paths to the chiller 70 and the evaporator 76. The second switching valve 80 is connected to the control device 98, and the control device 98 controls the operation of the second switching valve 80. As described above, the chiller 70 absorbs heat from the heating medium in the low temperature radiator circuit 10 and transfers the heat to the heating medium in the heat pump circuit 20. On the other hand, the evaporator 76 for cooling absorbs heat from air inside the vehicle (including outside air introduced from the outside into the vehicle) and transfers the heat to the heating medium in the heat pump circuit 20. The inside of the vehicle is thus cooled. The heat absorbed by the evaporator 76 is transferred from the condenser 84 to the high temperature radiator circuit 30.

The high temperature radiator circuit 30 mainly includes a main circuit 32 and a heating path 34. The main circuit 32 of the high temperature radiator circuit 30 is a circulation path that circulates the heating medium between the condenser 84 and the high temperature radiator 94. The main circuit 32 is provided with a third pump 88 that circulates the heating medium. The third pump 88 is located on the upstream of the condenser 84. The main circuit 32 dissipates the heat transferred from the heat pump circuit 20 from the high temperature radiator 94 to the outside air by circulating the heating medium. The main circuit 32 is further provided with a heater 86. The heater 86 is an electric heater. The heater 86 can heat the heating medium as needed. The heater 86 is connected to the control device 98, and the control device 98 controls the operation of the heater 86. The high temperature radiator circuit 30 is an example of the second other thermal circuit disclosed in the present specification.

The heating path 34 is in parallel with the high temperature radiator 94 and bypasses the high temperature radiator 94. A heater core 92 is located in the heating path 34. The heating path 34 branches from the main circuit 32 on the upstream of the high temperature radiator 94 and joins the main circuit 32 on the downstream of the high temperature radiator 94. A third switching valve 90 is located at an upstream end of the heating path 34 (that is, the branch point from the main circuit 32). The third switching valve 90 can switch the flow of the heating medium in the high temperature radiator circuit 30 between the high temperature radiator 94 and the heater core 92 and adjust the ratio of the flow rates in the flow paths to the high temperature radiator 94 and the heater core 92. The third switching valve 90 is connected to the control device 98, and the control device 98 controls the operation of the third switching valve 90. The heater core 92 dissipates heat from the heating medium flowing through the heating path 34 to air inside the vehicle (including outside air introduced from the outside into the vehicle). The inside of the vehicle is thus heated.

The thermal management system 100 further includes the second temperature sensor 95 and the third temperature sensor 97. The second temperature sensor 95 detects the temperature of the environment in which the thermal management system 100 is located. The third temperature sensor 97 detects the temperature of the battery 66. The temperature of the environment in which the thermal management system 100 is located is, for example, the temperature of outside air in a place in which the thermal management system 100 and a housing (in this case, the vehicle) including the thermal management system 100 are located. The second temperature sensor 95 may be mounted on the vehicle equipped with the thermal management system 100. For example, the second temperature sensor 95 may be mounted near a front grille through which outside air is introduced into the vehicle. The second temperature sensor 95 may be a device that acquires the ambient temperature of the vehicle from a data center connected via an appropriate communication network, based on information on the position of the vehicle. Such a device may be a communicable independent device or may be a part of the control device 98. The second temperature sensor 95 is connected to the control device 98, and the environment temperature detected by the second temperature sensor 95 is sent to the control device 98.

The third temperature sensor 97 is mounted in, for example, the battery 66. The battery temperature detected by the third temperature sensor 97 is, for example, the cell temperature of the battery 66. When the battery 66 includes a plurality of cells, the third temperature sensor 97 can also be mounted at a plurality of locations. The battery temperature detected by the third temperature sensor 97 is sent to the control device 98.

The thermal management system 100 includes the low temperature radiator circuit 10, the heat pump circuit 20, and the high temperature radiator circuit 30 that are independent of each other. In each of the circuits 10, 20, and 30, the path in which the heating medium flows can be switched as desired by the control device 98. For example, the thermal management system 100 can either selectively execute various modes such as a heating operation mode, a cooling operation mode, a heat-related device cooling operation mode, and a battery cooling operation mode, or combine any of the modes as appropriate and execute them. These operation modes will be described later.

The control device 98 of the thermal management system 100 is configured as a so-called computer including at least one processor and a memory. The memory stores a program to be executed when the first circuit 12 for cooling the battery 66 is operated. This program is a program for determining whether there is an abnormality in the first switching valve 40 during operation of the first circuit 12. The control device 98 can perform a series of steps of determining whether there is an abnormality in the first switching valve 40 based on the temperatures acquired from the first temperature sensor 44, the second temperature sensor 95, and the third temperature sensor 97.

The processor performs the series of steps of determining whether there is an abnormality in the switching valve by the switching valve abnormality determination program during operation of the first circuit 12. In the control device 98, the processor can acquire the heating medium temperature, the environment temperature, and the battery temperature from the first temperature sensor 44, the second temperature sensor 95, and the third temperature sensor 97, respectively, at predetermined timings during operation of the first circuit 12.

In the switching valve abnormality determination program, the processor determines whether the heating medium temperature is equal to or higher than a threshold temperature. The threshold temperature is a temperature based on a maximum temperature out of the environment temperature and the battery temperature. As used herein, the maximum temperature out of the environment temperature and the battery temperature is either the environment temperature or the battery temperature, whichever is higher. When the environment temperature and the battery temperature are the same, the maximum temperature out of the environment temperature and the battery temperature is this same temperature. The processor can specify the maximum temperature from the environment temperature and the battery temperature, and can specify the threshold temperature based on this maximum temperature.

The threshold temperature can be set in advance based on evaluations and experiments on the first switching valve 40. In one example, the threshold temperature can be set to a temperature higher than the maximum temperature by a certain temperature. Although this lower limit is not particularly limited, the lower limit of this certain temperature that is added to the maximum temperature is, for example, 3° C., 4° C., 5° C., or 7° C. The upper limit of this certain temperature that is added to the maximum temperature is, for example, 15° C., 13° C., 12° C., or 10° C. The range of this certain temperature can be set as desired from these lower and upper limits. The range of this certain temperature is, for example, a range of 5° C. to 15° C., or a range of 7° C. to 12° C. Since the threshold temperature is set to the temperature higher than the maximum temperature by this certain temperature, whether there is an abnormality in the first switching valve 40 can be accurately determined.

In another example, the temperature that is added to the maximum temperature may be different depending on, for example, the value of the specified maximum temperature. Alternatively, the temperature that is added to the maximum temperature may be different depending on whether the specified maximum temperature is derived from the environment temperature or the battery temperature. For example, the temperature that is added to the maximum temperature may be different depending on whether the specified temperature is the temperature detected by the second temperature sensor 95 or the temperature detected by the third temperature sensor 97. A table for setting such a threshold temperature may be stored in the first memory.

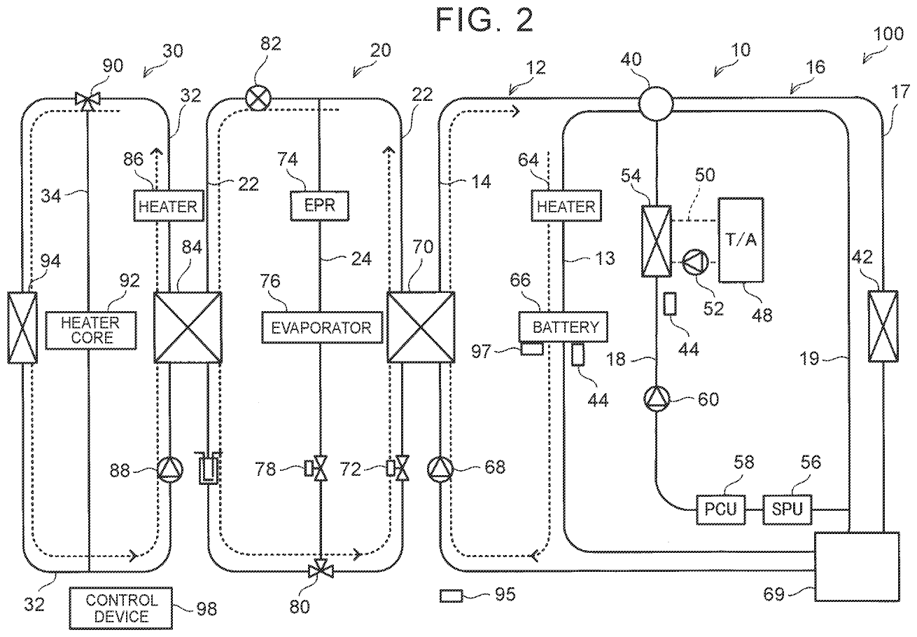

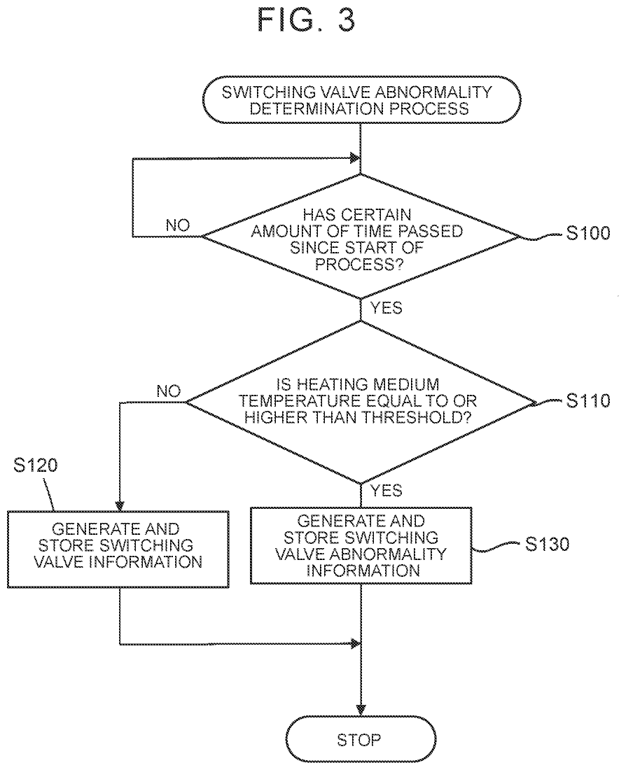

A cooling operation mode for the battery 66 that is executed by the thermal management system 100 is illustrated in FIG. 2, and a process flow of determining whether there is an abnormality in the first switching valve 40 between the first circuit 12 and the second circuit 16 in a battery cooling operation mode will be described with reference to FIG. 3 as an example of a process that is performed by the thermal management system 100.

### Battery Cooling Operation Mode

FIG. 2 shows a circuit in the battery cooling operation mode that can be executed by the thermal management system 100. FIG. 2 shows the battery cooling operation mode in the cooling operation mode. In the battery cooling operation mode, the control device 98 controls each unit of the thermal management system 100 in a manner shown in, for example, FIG. 2. In the high temperature radiator circuit 30, the third switching valve 90 and the third pump 88 are controlled so as to circulate the heating medium in the main circuit 32. In the heat pump circuit 20, the second switching valve 80 and the compressor 82 are controlled so as to circulate the heating medium in the main circuit 22. In the low temperature radiator circuit 10, the first pump 68 and the first switching valve 40 are controlled so that the first switching valve 40 allows the heating medium to flow in the first circuit 12 that includes the chiller path 14 and the battery path 13.

In the main circuit 22 of the heat pump circuit 20, the heating medium cooled by the condenser 84 thus flows into the chiller 70. The heating medium in the chiller path 14 is cooled by the chiller 70, and the cooled heating medium flows into the battery path 13 and cools the battery 66.

### Switching Valve Abnormality Determination Process

The flow shown in FIG. 3 is an example of a process that is performed by the control device 98 in response to a battery cooling request that is generated when it is detected that the temperature of the battery 66 is equal to or higher than a reference temperature. The control device 98 starts the battery cooling process and performs a process based on the switching valve abnormality determination program described below, in response to the battery cooling request. First, the control device 98 controls the first switching valve 40 and the first pump 68 so as to circulate the heating medium in the first circuit 12, in response to the battery cooling request.

The processor performs the process based on the switching valve abnormality determination program when the first pump 68 starts operating in response to the battery cooling request and the output of the first pump 68 reaches a level high enough to supply the heating medium to the first circuit 12. The processor performs the process when, for example, the indicated duty cycle of the output voltage of the first pump 68 is 30% or more, although the disclosure in the present specification is not particularly limited to this.

When the switching valve abnormality determination process starts, the processor measures the amount of time that has elapsed since the start of the process by a built-in timer and determines whether a certain amount of time has elapsed (step S100). By step S100, by providing wait time immediately after the first pump 68 starts operating, an erroneous determination can be avoided due to such as non-uniform temperature distribution of the heating medium in the first circuit 12. For example, when the vehicle equipped with the thermal management system 100 is stopped with the motor in the transaxle 48 etc. stopped, the battery path 13 and the chiller path 14 of the first circuit 12 may be heated inside the vehicle and the temperature of the heating medium may increase partially.

The above certain amount of time, that is, the amount of time for the non-uniform temperature distribution of the heating medium immediately after the first pump 68 starts operating to be eliminated, can be set in advance by evaluations, experiments, etc. that are carried out under various conditions. For example, this amount of time can be set in the range of about several tens of seconds to about several minutes and may be within one minute or within three minutes, although this amount of time is not particularly limited and varies depending on the path length of the first circuit 12 and the range in which the first circuit 12 extends.

When the processor determines in step S100 that the certain amount of time has elapsed since the start of the process, the processor performs an abnormality determination step of comparing the heating medium temperature in the first circuit 12 and the threshold temperature that is based on the maximum temperature out of the environment temperature and the battery temperature and determining whether the heating medium temperature is equal to or higher than the threshold temperature (step S110). The heating medium temperature is acquired from the first temperature sensor 44, the environmental temperature is acquired from the second temperature sensor 95, and the battery temperature is acquired from the third temperature sensor 97.

When the heating medium temperature does not reach the preset threshold temperature or is equal to or lower than the preset threshold temperature, the processor determines that there is no abnormality in the first switching valve 40, and performs the step of generating detected information (detected date and time, amount of time that has elapsed since the start of the process, heating medium temperature, environment temperature, battery temperature, threshold temperature, etc.) as switching valve information and storing the generated switching valve information in the memory (step S120). The process is then ended.

When the heating medium temperature is equal to or higher than the threshold temperature, the processor determines that there is an abnormality in the first switching valve 40, and performs the step of generating abnormality detected information (date and time when the abnormality occurred, amount of time that has elapsed since the start of the process, heating medium temperature, environment temperature, battery temperature, threshold temperature, etc.) as abnormality occurrence information and storing the generated abnormality occurrence information in the memory (step S130).

Moreover, the processor notifies the control device 98 that there is an abnormality in the first switching valve 40, and displays the abnormality of the first switching valve 40 in an appropriate display manner (for example, on an appropriately display unit) in the thermal management system 100 or the vehicle. The process is then ended.

Through the above series of steps, the thermal management system 100 can determine whether there is an abnormality in the first switching valve 40 during the operation of cooling the battery 66. Since whether there is an abnormality in the first switching valve 40 can be easily and accurately determined, the abnormality of the first switching valve 40 can be promptly handled, and degradation in performance of the battery 66 can be reduced or avoided. Moreover, since whether there is an abnormality in the first switching valve 40 can be determined at the start of the operation of cooling the battery 66, the abnormality can be promptly handled.

In the above process, the switching valve abnormality determination process being performed immediately after the start of the battery cooling operation is described. However, the timing of performing the switching valve abnormality determination process is not limited to this. For example, the switching valve abnormality determination process may be performed at any desired timing after the abovementioned certain amount of time has elapsed since the start of the battery cooling operation and before the end of the battery cooling operation. For example, the switching valve abnormality determination process may be set to be repeatedly performed at predetermined timings after the start of the operation of cooling the battery 66.

In the above process, the switching valve abnormality determination step will not be performed for the certain amount of time after the start of the battery cooling operation in order to avoid an erroneous determination being made while the vehicle is stopped. However, the disclosure in the present specification is not limited to this. For example, the thermal management system 100 may include temperature sensors that detect the heating medium temperature in the first circuit 12 at a plurality of positions in the first circuit 12. In this case, the processor may perform the step of acquiring the heating medium temperatures detected at the different positions in the first circuit 12 by these temperature sensors and detecting that the difference between or among the heating medium temperatures is equal to or smaller than a certain value. The processor may perform the switching valve abnormality determination step when the difference between or among the heating medium temperatures is equal to or smaller than the certain level in this step. In this case, whether there is an abnormality in the first switching valve 40 can thus be accurately determined without particularly setting a determination wait time after the start of the battery cooling operation.

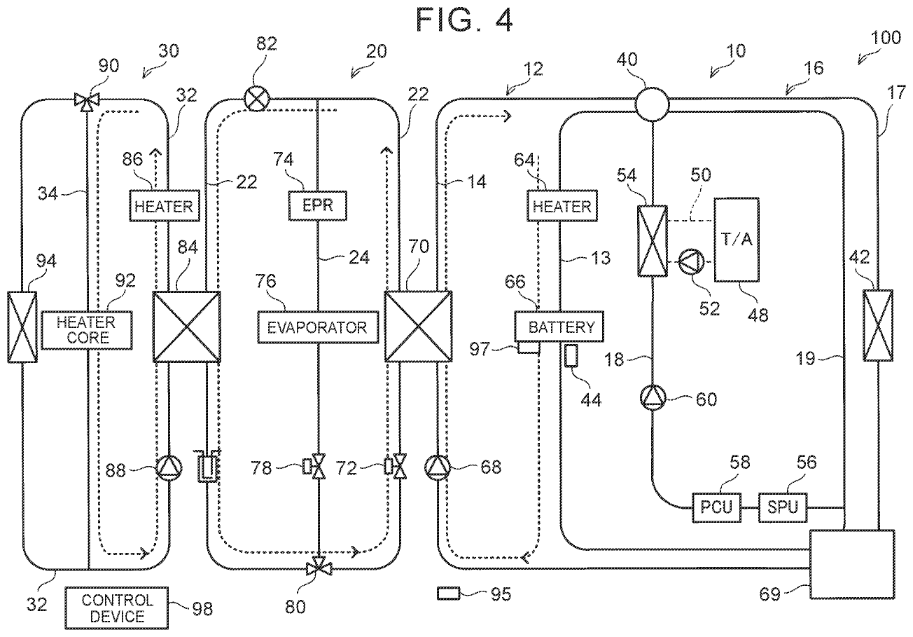

In the above process, the thermal management system 100 executes the battery cooling operation mode simultaneously with the cooling operation mode. However, the disclosure in the present specification is not limited to this. The battery cooling operation mode may be executed independently, or, as shown in FIG. 4, may be executed simultaneously with a heating operation mode by the thermal management system 100. That is, a heating operation may be performed by operating the high temperature radiator circuit 30 so as to circulate the heating medium in the heating path 34 and operating the heat pump circuit 20 in a manner similar to that in the cooling operation mode.

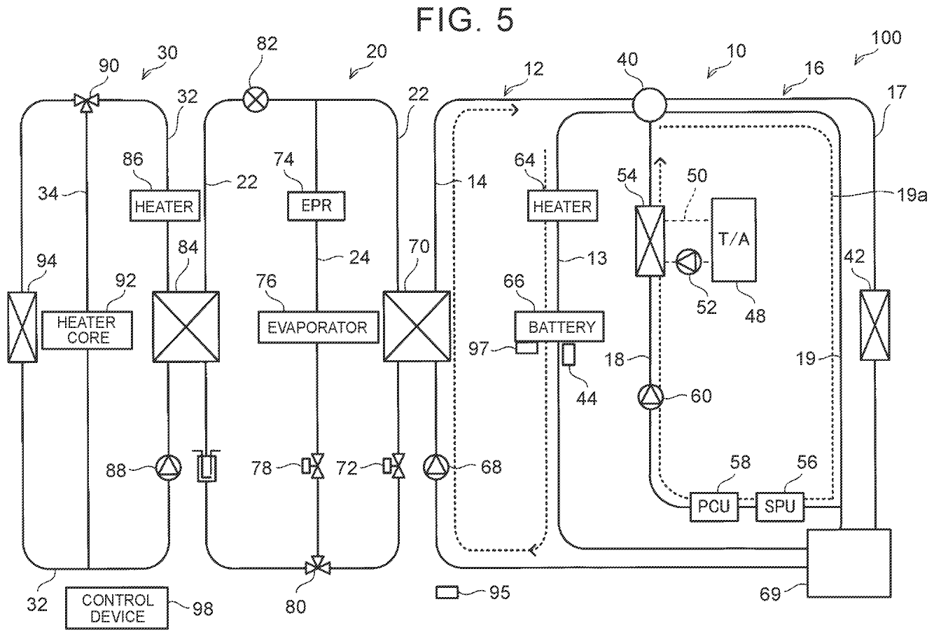

As shown in FIG. 5, the battery cooling operation mode may be selectively or simultaneously executed with a heat-related device cooling operation mode. The heat-related device cooling operation mode is a mode in which the heating medium is circulated in the second circuit 16 of the low temperature radiator circuit 10. For example, in order to perform the battery cooling operation and the heat-related device cooling operation simultaneously, the control device 98 controls the first switching valve 40, the first pump 68, and the second pump 60 so that the heating medium circulates independently in the first circuit 12 and in the second circuit 16. The heat-related devices and the transaxle 48 (motor) are cooled by cooling the heating medium in the low temperature radiator path 17 by the low temperature radiator 42 and causing the cooled heating medium to flow into the heat-related device path 18.

As shown in FIG. 5, in the thermal management system 100, the battery cooling operation mode may be selectively or simultaneously executed with a bypass circuit operation mode. The bypass circuit operation mode is a mode in which the heating medium is circulated in a bypass circuit 19a that is composed of the bypass path 19 and the heat-related device path 18 of the second circuit 16. For example, in order to execute the battery cooling operation mode and the bypass circuit operation mode simultaneously, the control device 98 controls the first switching valve 40, the first pump 68, and the second pump 60 so that the heating medium circulates independently in the first circuit 12 and in the bypass circuit 19a.

In the thermal management system 100, the first temperature sensor 44 is located on the outlet side (downstream side) of the battery 66. However, the disclosure in the present specification is not limited to this. For example, the first temperature sensor 44 may be located on the inlet side (upstream) of the battery 66, at a position downstream of the first switching valve 40 and closer to the first switching valve 40. In this case, the temperature of the heating medium that has not passed through the battery 66 can be detected.

The thermal management system 100 includes the chiller 70 as a cooler. However, the disclosure in the present specification is not limited to this. The thermal management system 100 may use a heat exchanger in addition to various known coolers.

In the above description, the thermal management system 100 is mounted on an electrically powered vehicle. However, the disclosure in the present specification is not limited to this. The thermal management system 100 may be used as a stationary thermal management system 100. The thermal management system 100 includes the battery cooling circuit (battery cooling system) for cooling the battery 66. However, the thermal management system 100 may be used as a cooling system for other batteries such as a fuel cell.

In the above description, the thermal management system 100 includes the heat pump circuit 20 and the high temperature radiator circuit 30. However, the thermal management system 100 need not necessarily include the heat pump circuit 20 and the high temperature radiator circuit 30. The thermal management system 100 can be any system that includes the intention of battery cooling.

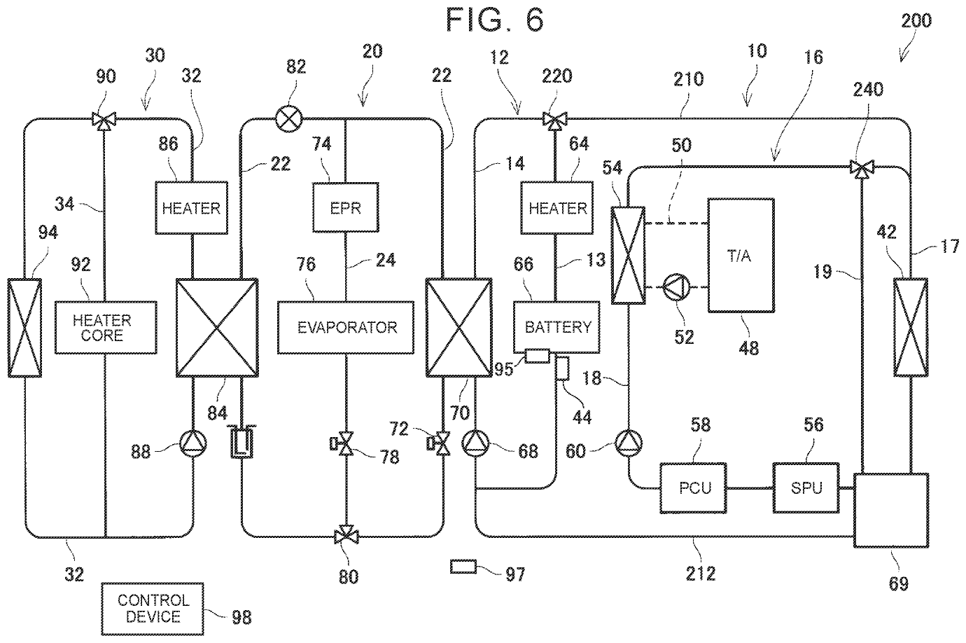

In the thermal management system 100, the first switching valve 40 is a five-way valve located at the connection portion between the first circuit 12 and the second circuit 16. However, the disclosure in the present specification is not limited to this. For example, the first circuit 12 and the second circuit 16 may be connected via a connection circuit. For example, in a thermal management system 200 shown in FIG. 6, the first circuit 12 and the second circuit 16 are connected via a connection path 210 and a connection path 212. Further, a first switching valve 220 may be provided at the connection portion between the first circuit 12 and the connection path 210. A switching valve 240 may be further provided at the branch portion of the bypass path 19 of the second circuit 16. In the case where the high temperature heating medium from the second circuit 16 flows into the connection paths 210, 212, the heating medium temperature in the first circuit 12 may increase when there is an abnormality in the first switching valve 220. The switching valve abnormality determination process disclosed in the present specification can also be applied to the first circuit 12 of the thermal management system 200.

Although the embodiment is described in detail above, the embodiment is merely illustrative and is not intended to limit the scope of the disclosure. The technique in the disclosure includes various modifications and alternations to the specific examples illustrated above. The technical elements described in the present specification and the drawings have technical usefulness alone or in various combinations, and are not limited to the combinations described in the specific examples. The disclosure illustrated in the present specification or the drawings can achieve a plurality of objects at the same time, and already has technical usefulness by achieving one of the objects.

What is claimed is:

1. A battery cooling system comprising:
a battery cooling circuit in which a heating medium that cools a battery circulates, the battery cooling circuit including a cooler path and a battery path, the cooler path being a path for cooling the heating medium, and the cooler path and the battery path being connected to each other;
a cooler that cools the heating medium in the cooler path;
the battery that is cooled by the battery path;
a combined cooling circuit that is a cooling circuit connected to the cooler path and the battery path at a connection portion between the cooler path and the battery path, the heating medium that is shared circulating in the combined cooling circuit;
a switching valve located at the connection portion between the cooler path and the battery path and configured to selectively allow and cut off communication between at least two paths, the at least two paths being selected from the cooler path, the battery path, and the combined cooling circuit;
a heating medium temperature sensor that detects a heating medium temperature, the heating medium temperature being a temperature of the heating medium circulating in the battery cooling circuit;
an environment temperature sensor that detects an environment temperature, the environment temperature being a temperature of an environment in which the battery cooling system is located;
a battery temperature sensor that acquires a battery temperature, the battery temperature being a temperature of the battery; and
a control device, wherein the control device determines whether there is an abnormality in the switching valve based on the heating medium temperature and a threshold temperature, the threshold temperature being a temperature associated with a maximum temperature out of the environment temperature and the battery temperature.

2. The battery cooling system according to claim 1, wherein the threshold temperature is a temperature that is higher than the maximum temperature by a predetermined temperature.

3. The battery cooling system according to claim 1, wherein the threshold temperature is set to a temperature that is higher than the maximum temperature by a temperature in a range of 5° C. to 15° C.

4. The battery cooling system according to claim 1, wherein the heating medium temperature sensor is located downstream of the switching valve.

5. The battery cooling system according to claim 1, wherein the switching valve is located at a connection portion between a downstream end of the cooler path and an upstream end of the battery path.

6. The battery cooling system according to claim 1, wherein the switching valve is a switching valve configured to selectively allow and cut off communication between at least two of the cooler path, the battery path, and a path in the combined cooling circuit.

7. The battery cooling system according to claim 1, wherein:
the combined cooling circuit includes a heat-related device path and a radiator path, the heat-related device path including a heat-related device that operates using power of the battery, and the radiator path including a radiator that exchanges heat between the heating medium cooling the heat-related device and outside air; and
the heating medium circulates in the combined cooling circuit.

8. The battery cooling system according to claim 7, wherein the combined cooling circuit further includes a bypass path that bypasses the radiator path.

9. The battery cooling system according to claim 1, further comprising a storage unit for the heating medium, the storage unit being located at another connection portion between the cooler path and the battery path, wherein the battery cooling circuit and the combined cooling circuit are connected via the switching valve and the storage unit.

10. The battery cooling system according to claim 1, wherein, when the heating medium starts circulating in the battery cooling circuit, the control device determines whether there is the abnormality in the switching valve based on the heating medium temperature and the threshold temperature after elapse of a certain amount of time from start of circulation of the heating medium.

11. The battery cooling system according to claim 1, further comprising a first other thermal circuit, the first other thermal circuit including a heat exchanger that cools the heating medium by heat exchange with another heating medium.

12. The battery cooling system according to claim 11, further comprising a second other thermal circuit that heats the other heating medium by heat exchange with a further another heating medium.

13. The battery cooling system according to claim 1, wherein the battery is a battery for a vehicle.

14. The battery cooling system according to claim 1, wherein the control device compares the heating medium temperature and the threshold temperature, and determines that there is the abnormality in the switching valve when the heating medium temperature is equal to or higher than the threshold temperature.

15. The battery cooling system according to claim 1, wherein the switching valve is a switching valve configured to selectively allow the cooler path and the battery path to communicate with the combined cooling circuit and cut off communication of the cooler path and the battery path with the combined cooling circuit.
